(19) United States
(12) Patent Application Publication
(10) Pub. No.: US 2003/0069838 A1
(43) Pub. Date: Apr. 10, 2003

(54) Method and system for monitoring and maintaining lines of credit secured by accounts receivable

(75) Inventor: Aidan H.F. Harland, Amissville, VA (US)

Correspondence Address: Joseph G. Seeber, Esq., Post Office Box 750, Great Falls, VA, 22066, US

(73) Assignee: SOUTHERN WEBTECH.COM, INC.

(21) Appl. No.: 09/974,115

(22) Filed: Oct. 9, 2001

(51) Int. Cl. G06F 17/60

(52) U.S. Cl. 705/38

(57) ABSTRACT

A method and system for monitoring and maintaining lines of credit secured by accounts receivable processes payments received from customers of a client so as to generate receipts data, and processes the receipts data so as to increase or decrease a line of credit extended to the client based on a collateral account, the value of which is dependant upon the receipts from the customers of the client and transfers from other accounts of the client. The system basically comprises a lockbox for receiving the payments and generating receipts data, and an invoice maintenance system maintained by a financial institution on behalf of the client for processing the receipts data, and generating both receivables data transmitted to an on-line borrowing and repayment system and update data transmitted to a client. The on-line borrowing and repayment system processes the receivables data and loan requests from the client so as to render, to the client, a loan decision relative to the line of credit to be extended to that client. Preferably, the system includes a parser, a system manager and a web module for generating entries, and for providing those entries to an entries table, a service table and a security table. The parser functions to determine whether or not a client is out of compliance with an established credit protocol.

### TECHNICAL FIELD

The present invention generally relates to a method for monitoring and maintaining lines of credit secured by accounts receivable, and to a web lines of credit (WebLOC) system for accomplishing that purpose.

### BACKGROUND ART

Business establishments, and in particular small businesses, often employ an external entity to manage their accounts receivable. For example, an accounting firm or a bank can be employed for that purpose.

In addition, business establishments (again, in particular, small businesses) often maintain lines of credit with a bank or other financial institution. In such cases, the amount of credit extended by the financial institution depends on various factors, such as: (1) funds on deposit in accounts with the bank or financial institution; (2) collateral pledged by the business as security for the extended line of credit, such collateral including real estate, business property, and so forth; and (3) in some cases, accounts receivable, that is, payments due to the business establishment from their clients or customers as a result of services performed by or products supplied to the customer or client by the business in question.

With the latter facts in mind, there is a need in the prior art for the development of a method and system for monitoring and maintaining lines of credit secured by accounts receivable. In particular, there is a need for a method and system wherein an interface between accounts receivable and extending lines of credit can be provided. More specifically, there is a need in the prior art for the development of a method and system wherein borrowings under an extended line of credit can be increased or decreased in a rapid and efficient manner in response to variation in the accounts receivable.

### DISCLOSURE OF INVENTION

The present invention generally relates to a method for monitoring and maintaining lines of credit secured by accounts receivable, and to a WebLOC system for accomplishing that purpose.

More specifically, the method and system for monitoring and maintaining lines of credit secured by accounts receivable provides an interface between the status of or variation in accounts receivable, on the one hand, and the amount of credit extended under a line of credit to the business establishment in question, on the other hand. The WebLOC system of the present invention basically comprises an invoice maintenance system maintained by a bank or financial institution on behalf of the business establishment (that is, the “client”), an on-line borrowing and repayment system also maintained by the financial institution, and a lockbox into which payments from customers of the client are deposited. In accordance with the invention, the financial institution has access to the lockbox so that receipts data can be downloaded into the invoice maintenance system. In turn, the invoice maintenance system provides receivables data to the on-line borrowing and repayments system. When a loan request is transmitted by the client to the on-line borrowing and repayment system, the latter generates a data request which is provided to the invoice maintenance system, the invoice maintenance system provides receivables data to the on-line borrowing and repayment system, and a loan decision can be transmitted by the borrowing and repayment system to the client in a timely and efficient manner.

Therefore, it is an object of the present invention to provide a method for monitoring and maintaining lines of credit secured by accounts receivable, and to a WebLOC system for accomplishing that purpose.

It is an additional object of the present invention to provide a method and system for monitoring and maintaining lines of credit secured by accounts receivable wherein an interface between the status of the accounts receivable and the permitted borrowings under a line of credit to the business establishment is provided.

It is an additional object of the present invention to provide a method and system for monitoring and maintaining lines of credit secured by accounts receivable wherein the system basically comprises an invoice maintenance system, an on-line borrowing and repayment system, and a lockbox for receiving payments from customers of the client-business.

The above and other objects of the invention will be more clearly understood by reference to the following detailed description and the accompanying drawings.

### BRIEF DESCRIPTION OF DRAWINGS

FIG. 1 is a block diagram of a system for monitoring and maintaining lines of credit secured by accounts receivable in accordance with the present invention.

FIG. 2 is a graphical representation used to illustrate the employment of a borrowing formula for the purpose of processing loan requests and rendering decisions as to line of credit.

FIG. 3 is a graphical representation used to illustrate the use of a collateral account in processing loan requests and rendering decisions on line of credit.

FIG. 4 is a block diagram used to illustrate the functions performed by a parser in accordance with the method and system of the present invention.

FIG. 5 is a flowchart of the operations performed by the parser of the present invention.

FIG. 6 is a flowchart of the operations performed by a system manager of the present invention.

FIG. 7 is a flowchart of the operations performed by a web module of the present invention.

FIG. 8 is a block diagram illustrating the various data entries provided by the parser, system manager and web module of the present invention.

### BEST MODE FOR CARRYING OUT THE INVENTION

The invention will now be described in more detail with reference to the various figures of the drawings.

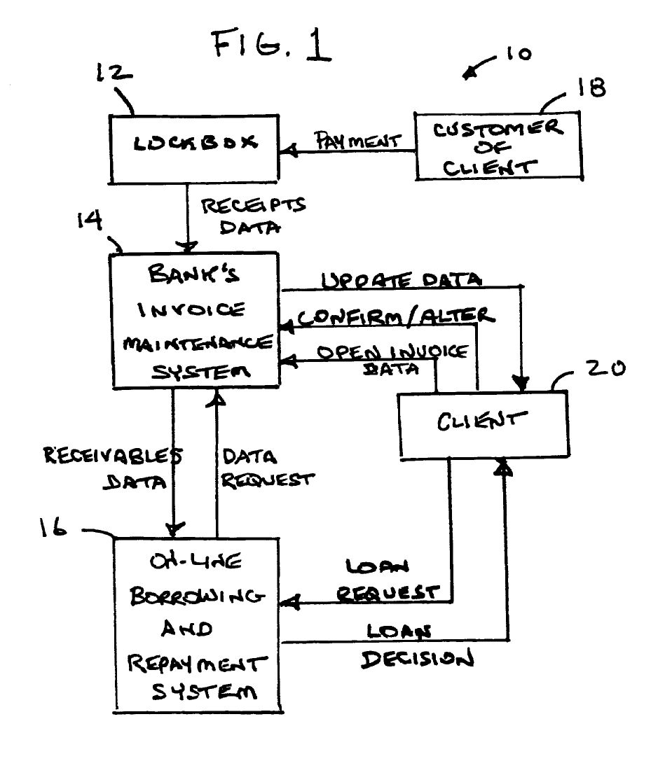

FIG. 1 is a block diagram of a system for monitoring and maintaining lines of credit secured by accounts receivable in accordance with the present invention. As seen therein, the system 10 of the present invention basically comprises a lockbox 12 for receiving payments from a customer or customers 18 of a client 20, an invoice maintenance system 14 maintained by a bank or financial institution on behalf of the client 20, and an on-line borrowing and repayment system 16 which receives loan requests from the client 20, processes those loan requests in accordance with receivables data received, upon request, from the invoice maintenance system 14, and renders loan decisions to the client 20.

Preferably, the system 10 employs a process on the Internet so that the client 20 has direct access to the system 10 via the Internet for the purpose of monitoring and maintaining its accounts receivable. Furthermore, the client 20 renders invoices to the customer 18, and instructs the customer 18 to transmit payments to the lockbox 12, the lockbox 12 being serviced by the financial institution to collect receivables on behalf of the client 20. The method and system of the invention also provide for receipt, by the financial institution, of FED Wires and ACH payments in payment of receivables on behalf of the client 20.

Data relative to receipts are transmitted from the lockbox 12 to the invoice maintenance system 14 over a secure web network. The client 20 is able to advise the financial institution of invoices sent out by performing periodic uploading of open invoices or open invoice data to the invoice maintenance system 14 from its own internal accounting system. This enables the receipts and invoices to be matched up by the financial institution. In the latter regard, update data relative to outstanding invoices and invoices for which receipts have been received are provided by the invoice maintenance system 14 to the client 20 on a periodic basis. In response, the client 20 can confirm, or as necessary, alter the allocation of a particular receipt to a specific invoice. Moreover, downloading of update data from the invoice maintenance system 14 to the client 20 over the web permits updating of the client's internal accounting system.

The on-line borrowing and repayment system 16 receives loan requests from the client 20, and processes them by generating data requests which are transmitted to the invoice maintenance system 14. The invoice maintenance system 14 responds to such data requests by transmitting receivables data to the on-line borrowing and repayment system 16. Once the receivables data are received by the on-line borrowing and repayment system 16, the system 16 is able to process the loan request from the client 20 and to render a loan decision which is then transmitted to the client 20.

More specifically, since the financial institution is aware of the status of the client's receivables via the invoice maintenance system 14, the on-line borrowing and repayment system 16 provides for on-line borrowing and repayment of a line of credit linked to the receivables of the client 20. Thus, each time the client 20 attempts to borrow money, an internal compliance check can be performed to see if the increase in borrowing is in compliance with a formula agreed to by the financial institution and the client in advance.

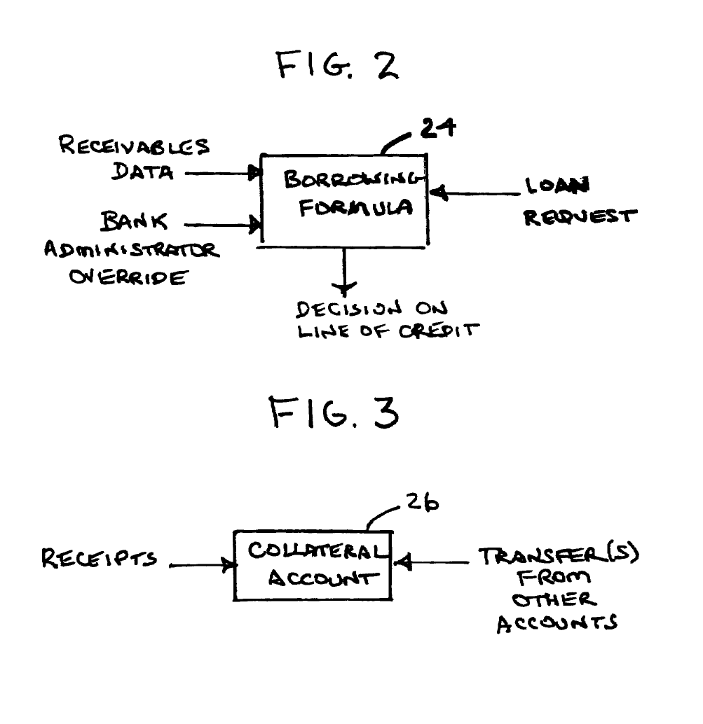

FIG. 2 is a graphical representation used to illustrate the employment of a borrowing formula for the purpose of processing loan requests and rendering decisions as to line of credit. Referring to FIG. 2, the borrowing formula 24 receives input data in the form of receivables data and a loan request, processes that data, and generates a decision on the borrowing base permitted under a line of credit available to the client 20. In particular, the formula 24 sets a borrowing base amount, and then calculates the gross amount of eligible receivables by eliminating any receivables that are considered stale, or “over concentration”, or possibly already paid from unallocated receipts. Staleness (drop off days) is set at the level of a client's customer (the payer), and is measured as a number of days from the original issue of an invoice. The financial institution can set a default period at the client level, which will automatically be assigned to any new payer.

As indicated in FIG. 2, a bank administrator has the capability of overriding at the payer level once appropriate credit approval has been provided. The term “concentration” used above refers to the total of receivables for one payer. A default is set at the client level and, in a manner similar to “drop off days”, it can be set at the payer level. The term “unallocated receipts” also used above applies to funds received by the financial institution but not yet allocated to a particular invoice. Obviously, such funds are to pay down a receivable, and therefore the collateral pool has no doubt been reduced. Thus, the amount of unallocated receipts that are already available funds is subtracted from receivables to obtain gross eligible receivables.

The bank agreement with the client can include a percentage of gross eligible receivables that will be considered as net eligible receivables. In addition, the bank might have another tranche of collateral (known as “other collateral”) which, when added to net eligible receivables, would give the total of collateral available. The bank will then permit borrowing up to the lesser of that figure or the approved line of credit (the borrowing base).

It should be understood that all of the capabilities just discussed above can, and preferably should be, programmed into the invoice payment system 14 and on-line borrowing and repayment system 16 in accordance with the present invention. It should be further understood that the invoice maintenance system 14 and on-line borrowing and repayment system 16 are implemented by appropriately programmed processors which, as indicated above, communicate over the web to receive receipts data from the lockbox 12, as well as confirm/alter data and open invoice data from the client 20 (in the case of the invoice maintenance system 14) and loan requests from the client 20 (in the case of the on-line borrowing and repayment system 16). Furthermore, the invoice maintenance system 14 generates, as discussed above, update data provided via the web to the client 20, while the online borrowing and repayment system 16 generates, via the web, loan decisions which are provided to the client 20.

In accordance with the system and method of the present invention, the user is provided with a “borrowing screen” that shows the result of the computations discussed above, and allows the user to “drill down” to view components of the calculation. It also allows the user to increase or decrease the loan amount. A user can register a number of demand deposit accounts (DDAs) to handle loan transactions.

FIG. 3 is a graphical representation used to illustrate the use of a collateral account in processing loan requests and rendering decisions on line of credit. Referring to FIG. 3, the main account or collateral account 26 is specified in the loan/lockbox agreement between the client 20 and the financial institution as the account into which all receipts must be directed, after which the bank or financial institution has authority to debit or credit in order to administer compliance with the loan agreement. The user is free to move funds via system transfers to and from other accounts, and into the collateral account 26, so long as the user is compliant.

In accordance with the invention, the system as described above communicates with a data base administrator, a credit account officer and client 20 by means of screen dialog boxes, email, and reports generated by the system. If the client 20 attempts to borrow more funds than are permitted, a screen dialog box will so advise the client 20. If the client 20 performs a successful increase or decrease of borrowing over the web, a screen dialog box will confirm the details, and a “hard copy” will be provided via email. If the client 20 goes out of compliance, for example, by a drop off of stale receivables, a negative amount available will be reported to the client 20 on the borrowing screen the next time the client accesses that screen. In addition, a report is provided to the system administrator daily, and after a number of days (set at the client level), a notification is sent to the client. The system can be set to automatically monitor the status of the client, and to reduce the loan amount by usage of funds in the collateral account 26 (FIG. 3) with appropriate advisories being sent to the client 20 by email.

Referring to FIG. 4, which is a block diagram used to illustrate the functions performed by a parser in accordance with the method and system of the present invention, the system of the present invention is designed to interact with the core processor 32 of the financial institution, and in particular with the account system or software implemented in core processor 32. As a result, whenever a DDA or loan balance figure is shown on a display screen or is relied upon, the core processor 32 is accessed in order to obtain a real-time figure. Thus, whenever the client or the system debits or credits a loan account or DDA account, the information is immediately transmitted by parser 48 to the core processor 32 so that the accounting system in core processor 32 is updated “real time”.

It should be understood that the system of the present invention can be modified by a person of ordinary skill in the art in order to provide links to other core processors in the future. In addition, it should also be recognized that the system of the present invention can be modified so that it can be licensed to and implemented by, or in conjunction with, the internal processing system of a financial institution. Such a modification can result in a real-time or batch system, and a batch system would be set to upload flat ASCII files to the accounting system of the financial institution on a daily basis.

Further referring to FIGS. 1 and 4, the system 10 performs a receipts function by receiving payments from the customer 18 of the client 20 in the lockbox 12, such payments being in the form of checks or other receipt items. The system is so designed as to provide information from an abstract file in an appropriate format so as to convey brief details relative to checks and other receipt items received in the lockbox 12.

In particular, referring to FIG. 4, a check scanner 30 (such as the one manufactured by Digital Check Corporation) is used to scan checks and the accompanying remittance or payment slips received from the customer 18 of the client 20. Available software (such as that produced by Contact Innovations, Inc. of Toronto, Canada) is used to process the data resulting from scanning of the checks and the remittance or payment slips so as to obtain routing number information from the bottom of the checks, as well as invoice number and other information from the remittance slips by use of an optical character reader (OCR) in the scanner 30. In addition, the scanner 30 can perform the function of endorsing the scanned check or other item for further processing, as needed.

The information derived by the scanner 30 is then provided, in the form of an extract file, to the parser 48 which parses the file so as to determine debits and/or credits corresponding to the scanned items. The debit/credit information is provided by the parser 48 to core processor 32 with appropriate value date information resulting from examination of the routing number on the check. With respect to the “value date” information, preferably, FED Wires are considered to be immediately available funds, while ACH receipts are parsed for the value date advised in the NACHA style file received.

In conjunction with the latter procedure, the system of the present invention separates the checks received into value dates according to the routing number, and makes separate “batches” or deposits for each value date according to “On Us”, “Local” or “Out of State” items. The number of hold days applied to local and out-of-state checks can be set at the client level.

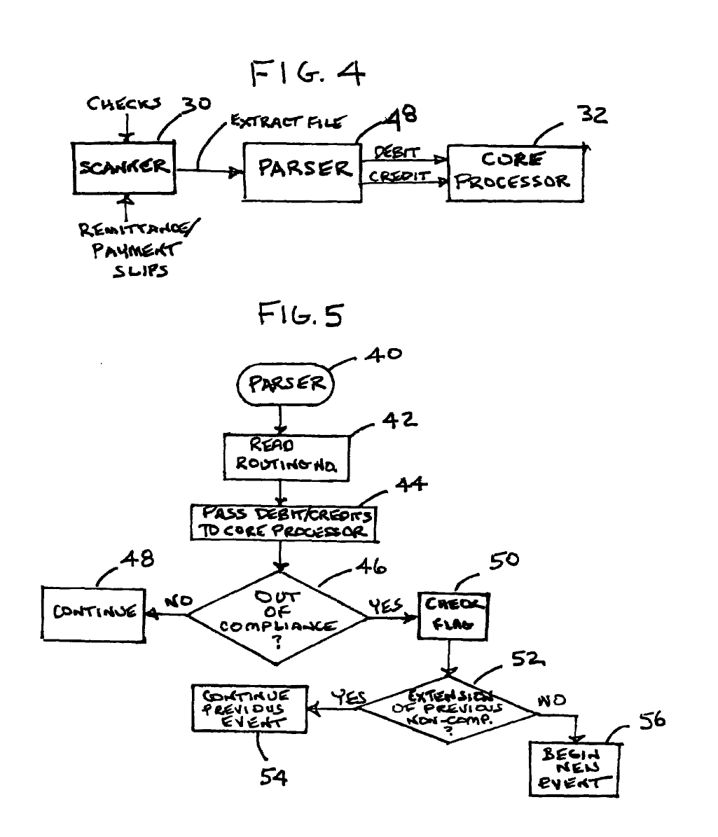

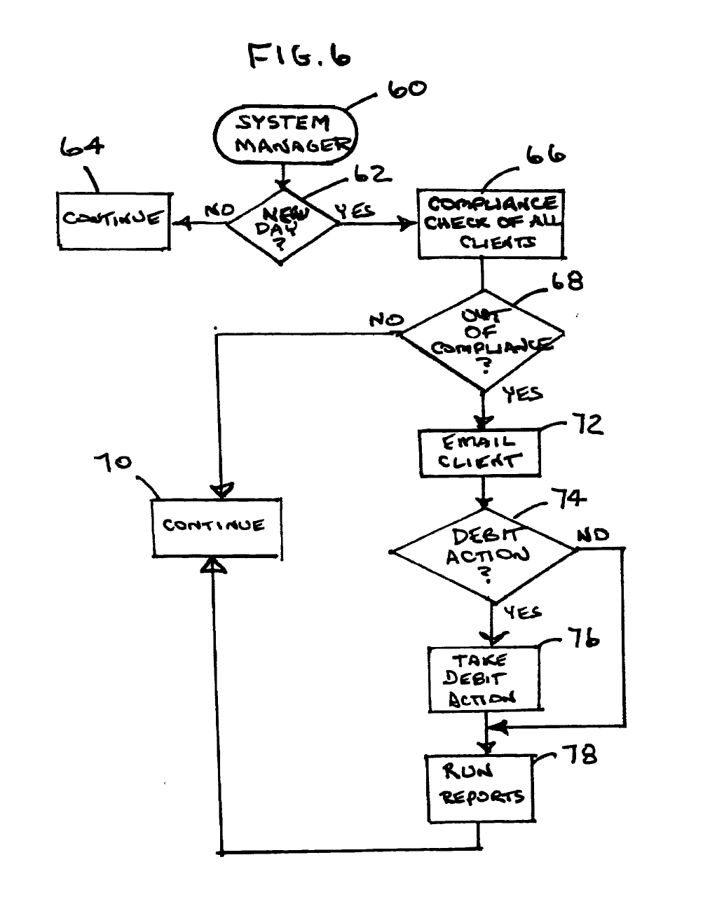

Thus, referring to FIG. 5, which is a flowchart of the operations performed by the parser of the present invention, the parser 48 reads or determines the routing number of a check or other receipt item from information provided by the scanner 30 of FIG. 4 (see step 42 of FIG. 5). As previously mentioned, debits and credits are passed to the core processor 32 of FIG. 4 (see step 44 of FIG. 5). The parser 48 then proceeds to perform a “compliance check” in order to determine whether the client 20 is out of compliance as a result of the currently received receipts reducing the level of receivables (see step 46).

If the client is out of compliance, a flag is checked at the client level (see step 50) in order to determine whether the current lack of compliance is an extension of a previous event of non-compliance (see step 52). If the flag in question is “empty” (that is, this is not an extension of a previous event of non-compliance), the flag is filled in with the current date as the beginning of a new event of non-compliance, and the new event is commenced (step 56). On the other hand, if it is determined (in step 52) that this is an extension of a previous event of non-compliance, the previous event is continued (step 54).

It should be noted that, if the Debit Delay number of days of the client 20 (FIG. 1) were to be zero, the system of the present invention would immediately try to take action to reduce the loan. This would require, however, that the funds in the collateral account 26 (FIG. 3) be available. If debit action is taken, preferably, emails are generated and transmitted to the client 20 and to the credit account officer of the financial institution.

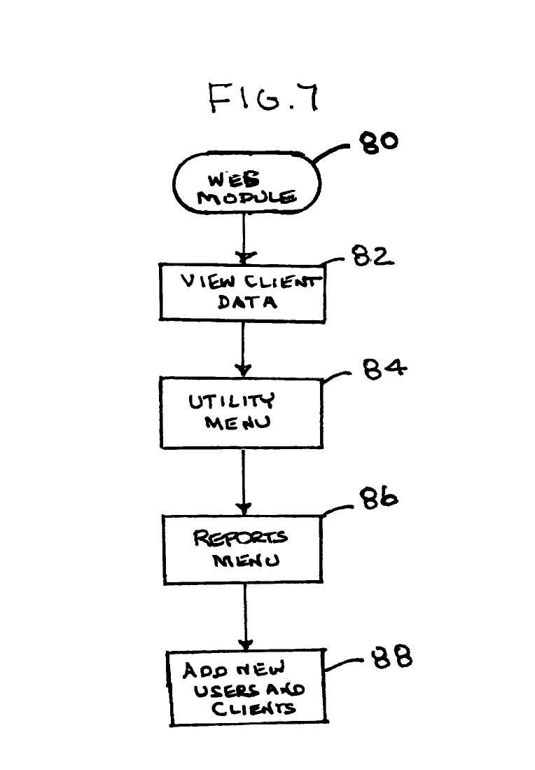

FIG. 6 is a flowchart of the operations performed by a system manager of the present invention. The system manager module runs certain administrative duties and includes a scheduler. It enables a compliance check of all clients to be run just after the opening of a new accounting day. It also runs and distributes reports and notices.

Thus, referring to FIG. 6, the system manager 60 determines whether a new day has occurred (step 62). If not, operation proceeds or continues as normal (step 64). On the other hand, if it is a new day, a compliance check of all clients is run, and reports and notices can be run and distributed. If a client has been out of compliance for a certain number of days (set at the client level by the system administrator), as determined in step 68, an email is sent to the client (step 72), politely advising the client to comply. Preferably, a copy of that email is sent to the credit account officer. On the other hand, if the client is not out of compliance, operation proceeds or continues in a normal fashion (step 70).

Once an email is sent to the client (step 72), a determination is made as to whether or not a debit action should be taken (step 74). If a debit action should be taken, that debit action is taken (step 76). If a debit action need not be taken, or once a debit action is taken, a set of reports is run to assist administration in control of the portfolio, as well as the accounting process (step 78). In the latter regard, an important daily report is a listing of DDA and general ledger entries which have taken place the previous day, as well as a reconciliation of lockbox receipts. In addition, preferably, an email is sent to each credit account officer having non-compliant clients, noting the day that the client in question went non-compliant, and the relevant numbers involved.

FIG. 7 is a flowchart of the operations performed by a web module of the present invention. Administration of the system is principally carried out by the ARTS web module 80, which is the main module run on a web server for clients and bank staff to access. The bank personnel deemed authorized to have access to this module can log in with the term “BANK” plus their user name or identity and their password. The “BANK” user can be designated as the administrator, in which case he or she is given full rights to add new users, change client profiles, and so forth. A regular “BANK” user can only view data, and a credit account officer (for example) will be such a user.

Referring to FIG. 7, after logging onto the web module 80, the user can elect to view the client data of a particular client (step 82), or can go to a utility menu (step 84). In the utility menu, such procedures as changing password and the like can be carried out.

Furthermore, after log-on, the user can go to the reports menu (step 86), wherein a number of reports are available. Such reports include a “status” report containing information regarding loan and compliance details. A “BANK” user with administrator rights can add new users and clients or alter their profiles by proceeding to a further stage in the web module 80 (specifically, step 88). In addition, such a “BANK” user can unlock “locked out” clients (which might result from an excessive number of incorrect attempts to log in). When the administrator elects to log in this particular client, they are able to act in all matters as that client. Of course, all actions are recorded in a history table of the web module 80 for subsequent audit.

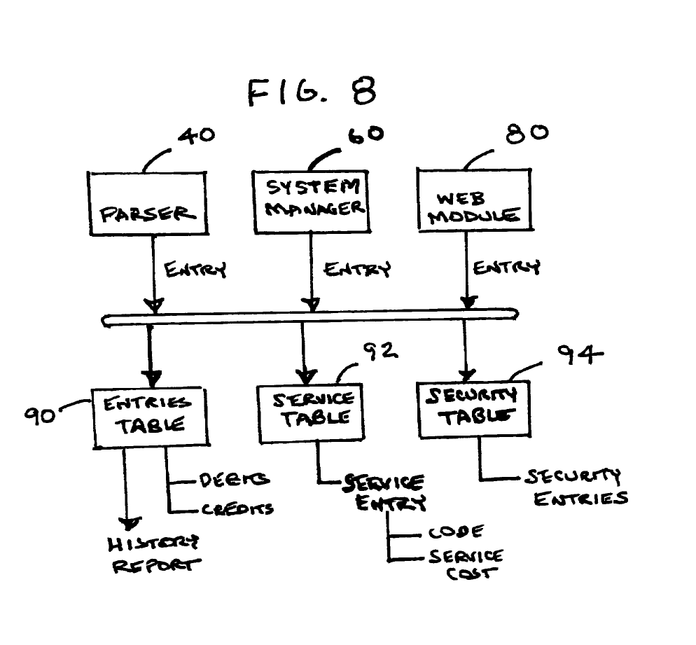

FIG. 8 is a block diagram illustrating the various data entries provided by the parser, the system manager and the web module of the present invention. Referring to FIG. 8, throughout the operation of the parser 40, the system manager 60 and the web module 80, various entries are dropped into various tables in order to provide a proper audit trail. For example, each debit or credit goes into an entries table 90, and this table 90 enables the system to report the history of a loan or a collateral account (such as collateral account 26 of FIG. 3).

Furthermore, service entries are dropped into service table 92 (FIG. 8) whenever certain events take place. Such events include the following: going out of compliance, receiving so many checks, borrowed funds, etc. Associated with each service entry is a code and a service cost. This is to enable the bank to analyze the usage of the system by its clients, and to possibly pass charges on to the client on the basis of the data.

Finally, throughout the system, entries are dropped into a security table 94 in order to report events that are of significance from a security point of view. Such security entries pertain, for example, to lockouts due to the use of a wrong password, the change of key data such as DDA information on a client profile, and so forth.

Returning to FIG. 1, as mentioned above, a client 20 can upload open invoice data over the web into the invoice maintenance system 14. This requires the client to format a report of “open invoices” from the particular accounting system which they use (for example, QUICK BOOKS, PEACHTREE, or other accounting system), and to upload the report via the web module 80 (FIG. 7). The uploaded files are archived for future audit purposes.

The system of the present invention parses the invoice data, noting any invoices for new payers, and setting up a payer in the system if the payer is not already present in the system. In addition, the system determines whether the invoice is already present in current data, and then merely updates the balance. If any invoice in the table is no longer reported as “open”, the balance is set to zero. With respect to any invoice already in the table but having its issue date changed, the issue date is left as is if the new date is more recent, and an entry noting the occurrence is dropped (see FIG. 8). On the other hand, any invoice with a future issue date is ignored. At the time of parsing an upload, it is considered that the bank and the client are in synchronization regarding allocation of receipts, and therefore the unallocated pool is emptied out.

As noted above, the client 20 using the system of the present invention will be afforded the opportunity to see new receipts lined up with invoices to which the receipts are payments. The client 20 has the ability, in accordance with the present invention, to allocate a receipt to one invoice or another. When viewing the image of a check received, the client 20 can conveniently find the invoice for which the check is a payment, and can allocate it at that time. If a mistake is made, the client 20 can deallocate the payment.

In addition, any receipts not assigned to an invoice are put in the “unallocated” category or pool. The sum of the receipts not assigned to an invoice and placed in the unallocated pool is deducted from receivables to arrive at gross eligible receivables during the compliance calculation. However, any ledger balances in the collateral account which are, as yet, unavailable due to routing number logic are added back. This is done for the sake of fairness, that is, in order not to show a client as non-compliant as a result of a receipt that the client does not as yet have access to.

In accordance with the invention, preferably, a color coding system is applied for display of data by the system in order to facilitate the client's visualization on the web of those receipts which have not yet been allocated. Thus, preferably, receipts not yet dealt with are displayed in red, and receipts dealt with are displayed in black. It is assumed that the client will update its own accounting system at the same time as viewing and allocation of a receipt on the screen takes place. However, if the client opts to take advantage of the upload capability, the system of the invention does not mark a receipt as uploaded until an upload actually takes place.

When all receipts in a batch (that is, in a group of deposits) have been allocated, the entire deposit, as listed on the browse list of deposits, turns from red to black. The method and system of the present invention allow the user to initiate queries as to allocated deposits, unallocated deposits, and all deposits. The method and system also permit the user to zoom in or zoom out on checks, and to list all images at once for performing a printout of all images in a deposit, including any remittance slips that might have accompanied them.

In the invoice area of the inventive system, the client 20 can add, edit or delete a new or existing invoice. However, most clients will rely on electronic uploads. This will have an immediate effect on compliance, and will be displayed the next time the user goes to the borrowing screen.

While preferred forms and arrangements have been shown in illustrating the invention, it is to be understood that various changes and modifications may be made without departing from the spirit and scope of this disclosure.

1. A method for monitoring and maintaining lines of credit secured by accounts receivable, comprising the steps of:
(a) receiving payments from customers of a client;
(b) generating receipts data relative to the payments received from the customers of the client;
(c) processing the receipts data so as to generate receivables data and update data;
(d) providing the update data to the client;
(e) receiving a loan request from the client;
(f) processing the loan request and the receivables data so as to generate a loan decision; and
(g) providing the loan decision to the client.

2. The method of claim 1, further comprising the steps of:
receiving changes to the receivables data from the client; and
altering the receivables data in accordance with the changes to the receivables data received from the client.

3. The method of claim 1, further comprising the step of receiving and processing an override request so as to alter the loan decision prior to providing the loan decision to the client.

4. The method of claim 1, further comprising the step of providing a collateral account having a value dependent on receipts from the customers of the client and transfers from other accounts of the client.

5. The method of claim 1, further comprising the step of providing a parser for processing the payments received from the customers of the client, the parser executing the steps of:
reading a routing number by scanning a check received from a given customer of the client; and
providing at least one of debits and credits to a core processor.

6. The method of claim 5, wherein the parser executes the additional steps of:
determining whether the client is out of compliance with respect to a credit protocol; and
when it is determined that the client is out of compliance with the credit protocol, checking a flag to determine whether a current non-compliance is an extension of a previous non-compliance.

7. The method of claim 6, wherein the parser performs the additional steps of:
when it is determined that the current non-compliance is an extension of the previous non-compliance, continuing the previous non-compliance; and
when it is determined that the current non-compliance is not an extension of the previous non-compliance, beginning a new event of non-compliance.

8. The method of claim 1, further comprising the step of providing a system manager which executes the steps of:
determining whether a new business day has started; and
when it is determined that the new business day is started, performing a compliance check of all clients.

9. The method of claim 8, wherein the system manager further carries out the steps of:
determining whether a given client is out of compliance with respect to a credit protocol; and
when it is determined that the given client is out of compliance with respect to the credit protocol, transmitting an email notification to the client.

10. The method of claim 9, wherein the system manager carries out the additional steps of:
determining whether a debit action with respect to the given client is to be initiated;
when it is determined that the debit action with respect to the given client is to be initiated, initiating the debit action; and
generating reports relative to all determinations as to whether the debit action is to be initiated.

11. The method of claim 1, further comprising the step of providing a web module for viewing client data, and executing at least one of a utility menu and a reports menu.

12. The method of claim 11, wherein the web module additionally operates to add new users and clients for which the accounts receivable are to be monitored and maintained.

13. The method of claim 1, further comprising the step of providing at least one of a parser, a system manager and a web module for generating entries, the method further comprising the step of providing at least one of an entries table, a service table and a security table for receiving the entries, and responsive to the entries for generating output data.

14. The method of claim 13, wherein the entries table is responsive to debit and credit entries for generating a history report.

15. The method of claim 13, wherein the service table is responsive to service entries for generating a report including at least one of a code and a service cost.

16. The method of claim 13, wherein the security table is responsive to security entries for generating a report of the security entries.

17. A system for monitoring and maintaining lines of credit secured by accounts receivable, comprising:
lockbox means for receiving payments from customers of a client, and for generating receipts data;
invoice maintenance means responsive to the receipts data from the lockbox means for generating receivables data and update data, and for providing the update data to the client; and
on-line borrowing and repayment means responsive to the receivables data and to a loan request received from the client for generating a loan decision and transmitting the loan decision to the client.

18. The system of claim 17, wherein the invoice maintenance means is responsive to changes to the receivables data received from the client for altering the receivables data.

19. The system of claim 17, wherein the on-line borrowing and repayment means is responsive to an override received from an administrator for altering the loan decision.

20. The system of claim 17, further comprising at least one collateral account established for a given client, the collateral account having a value dependent upon receipts of payments from the customers of the given client and transfers from other accounts of the given client.

21. The system of claim 17, further comprising parser means for processing extract file data developed as a result of scanning of checks received as payments from the customers of the client, said parser means generating debits and credits, the system further comprising core processor means for receiving and processing the debits and credits from the parser means.

22. The system of claim 21, wherein the parser means reads routing numbers from the checks received as payments from the customers of the client, passes the debits and credits to the core processor means, determines whether a given client is out of compliance with respect to a credit protocol, and checks a flag when it is determined that the given client is out of compliance with respect to the credit protocol.

23. The system of claim 22, wherein the parser means determines. based on the checking of the flag, whether a current non-compliance is an extension of a previous noncompliance, and wherein the parser means continues the previous non-compliance when it is determined that the current non-compliance is an extension of the previous non-compliance, and begins a new non-compliance when it is determined that the current non-compliance is not an extension of the previous non-compliance.

24. The system of claim 17, further comprising system manager means for determining whether a new business day has begun, and for conducting a compliance check of all clients when it is determined that the new business day has begun.

25. The system of claim 24, wherein the system manager means determines whether a given client is out of compliance with respect to a credit protocol, and transmits an email notification to the given client when it is determined that the given client is out of compliance with respect to the credit protocol.

26. The system of claim 25, wherein the system manager means determines whether a debit action is to be initiated, initiates the debit action when it is determined that the debit action is to be initiated, and generates reports with respect to all determinations as to whether the debit action is to be initiated.

27. The system of claim 17, further comprising web module means for viewing client data, and for generating at least one of a utility menu and a reports menu.

28. The system of claim 27, wherein the web module means adds new users and clients for which the accounts receivable are to be monitored and maintained.

29. The system of claim 17, further comprising at least one of parser means, system manager means and web module means for generating entries, and at least one of an entries table, a service table and a security table for receiving the entries.

30. The system of claim 29, wherein said entries table is responsive to the debit and credit entries for generating a history report.

31. The system of claim 29, wherein said service table is responsive to service entries for generating a report including at least one of a code and a service cost.

32. The system of claim 29, wherein said security table is responsive to security entries for generating a report of the security entries.
